(19) United States
(12) Patent Application Publication
(10) Pub. No.: US 2024/0247131 A1
(43) Pub. Date: Jul. 25, 2024

(54) METHODS TO ENHANCE THE MECHANICAL RECYCLABILITY OF POLYMERS WITH SELF-HEALING PROPERTIES

(71) Applicant: SAUDI ARABIAN OIL COMPANY, Dhahran (SA)

(72) Inventors: Haleema Alamri, Alkhobar (SA); Maryah Almaghrabi, Thuwal (SA); Aziz Fihri, Paris (FR)

(73) Assignee: SAUDI ARABIAN OIL COMPANY, Dhahran (SA)

(21) Appl. No.: 18/157,098

(22) Filed: Jan. 20, 2023

(51) Int. Cl. C08K 9/08; C08J 3/24

(52) U.S. Cl. CPC C08K 9/08; C08J 3/24; C08J 2333/14; C08K 2201/005

(57) ABSTRACT

Provided is a crosslinking agent that has a core particle and a shell on the surface of the core particle. The shell has at least one polymacrolactone. Also provided is a polymeric composite including a polyolefin matrix having at least one polyolefin and the crosslinking agent. The polyolefin is functionalized to include functional groups. Further, a method of preparing the polymeric composite composition and an article are provided.

### BACKGROUND

Plastic pallets are still a niche product as compared to their wooden counterparts due to many limitations and challenges. However, interest in plastic pallets is increasing. Engineered plastic pallets are considered the fastest growing alternative to wood due to characteristic properties such as durability and hygiene.

The materials most commonly used in plastic pallets are polypropylene (PP) and polyethylene (PE). PP is a thermoplastic polymer with many properties similar to those of high-density PE. However, PP has a higher tensile strength, it is harder and more elastic, as well as more transparent and radiant, with equal gas and vapor permeability. PP has certain drawbacks including is its low impact strength, especially at lower temperatures. This disadvantage may be overcome by copolymerization of propylene with other α-olefins or by the addition of fillers. PE is favored for pallet applications because of its low cost, uniform performance, availability, excellent resistance to impact, and good performance under a wide range of operating conditions. PE is useful in indoor and outdoor applications and exhibits chemical resistance to most acids and bases.

There is a need to develop recyclable or reprocessable plastic materials with good impact resistance and durability properties for the next generation of composite plastic pallets. Obtaining strong, cost-effective pallets which can withstand high loadings and multiple uses, as well as can be recycled and reused multiple times requires materials that have the strength of thermosets (crosslinked polymers), but can be recycled and reused multiple times like thermoplastics.

Vitrimer composites can behave as typical thermoset polymers at room temperature (highly cross-linked) and alter their network topology at higher temperatures. These properties provide a new scope for polymeric materials by combining reshaping or recycling performance with dimensional stability. In contrast to thermosets, which have a definitive shape after curing, vitrimers exhibit a high but restricted viscosity, which allows new shaping, repair and reprocessing capabilities.

Accordingly, there exists a need for vitrimer-type polymeric composite compositions which can be recycled and reprocessed for plastic pallet applications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a crosslinking agent comprising a core particle and a shell on the surface of the core particle, the shell comprising at least one polymacrolactone.

In another aspect, embodiments disclosed herein relate to a polymeric composite comprising a polyolefin matrix and a crosslinking agent. The polyolefin matrix comprises at least one polyolefin, that is functionalized to comprise functional groups. The crosslinking agent comprises a core particle and a shell on the surface of the core particle. The shell comprises at least one polymacrolactone.

In another aspect, embodiments disclosed herein relate to an article comprising a polymeric composite comprising a polyolefin matrix and a crosslinking agent. The polyolefin matrix comprises at least one polyolefin, that is functionalized to comprise functional groups. The crosslinking agent comprises a core particle and a shell on the surface of the core particle. The shell comprises at least one polymacrolactone.

In another aspect, embodiments disclosed herein relate to a method of preparing a polymeric composite composition. The method includes melting a polyolefin matrix to form a melted polyolefin matrix and mixing a crosslinking agent with the melted polyolefin matrix to form the polymeric composite composition. The crosslinking agent comprises a core particle and a shell on the surface of the core particle. The shell comprises at least one polymacrolactone.

Other aspects and advantages of the claimed subject matter will be apparent from the following description and the appended claims.

### BRIEF DESCRIPTION OF DRAWINGS

FIG. 1 is a schematic of the preparation of silica-PML from silica particles and polymacrolactones.

FIG. 2 is a schematic of the preparation of the polymeric composite composition from HDPE-g-GMA and silica-PML.

### DETAILED DESCRIPTION

Embodiments disclosed herein generally relate to a polymeric composite composition comprising a polyolefin matrix, a crosslinking agent, and optionally, additives. The polyolefin matrix is dynamically crosslinkable to form a vitrimeric composite from cost effective materials. The vitrimeric nature of the composite allows for a composition which can behave as a typical thermoset at room temperature, but can alter the crosslinked network topology at elevated temperatures. This allows for the polymeric composite composition to be reshaped, repaired, and/or reprocessed. The polymeric composite composition may also self-heal, which provides enhanced durability.

The vitrimeric nature of the composite arises from the use of a dynamic covalent bond formed between the polyolefin matrix and a crosslinking agent. In order to improve the strength of the final composite, the crosslinking agent may be produced from filler materials which are used as common additives to polymeric compositions. The filler materials are functionalized with polymers to provide functional groups capable of forming a dynamic covalent bond with a functional group present in the polyolefin matrix.

### Crosslinking Agent

The polymeric composite composition in accordance with the present disclosure comprises a crosslinking agent. The crosslinking agent may react with the polyolefin matrix to form reversible, dynamic covalent crosslinks. Such dynamic crosslinks impart vitrimeric properties to the polymeric composite. The crosslinking agent may be a particle comprising functional groups capable of forming the dynamic covalent crosslinks with the functional groups of the polymer matrix. The particle may be a core-shell particle comprising a core particle which is functionalized to introduce functional groups on the surface of the particle (i.e., the shell) which form dynamic covalent crosslinks.

The core particle may be a silica particle. Alternatively, the core particle may comprise oxides of titanium, zinc, silver, copper, aluminum, nickel, or any other suitable material. Core particles may have an average size ranging from a lower limit of any one of 25 nm, 50 nm, 75 nm, 100 nm, 200 nm, 300 nm, 400 nm, and 500 nm to an upper limit of any one of 800 nm, 1 μm, 2 μm, and 3 μm, where any lower limit may be used in combination with any upper limit. The core particles may have a particle size distribution of less than 2, such as in the range from about 1 to 1.7, or 1.1 to 1.5; and/or the core particles may be provided having a particle size distribution where the D90 is 100 μm, 125 μm, 150 μm, 200 μm, 300 μm, 500 μm, 800 μm, 1 μm, 2 μm, or 5 μm.

The core particle may be functionalized with at least one polymer to introduce functional groups that form a shell comprising the desired functional groups. The end groups of the polymers may comprise the desired functional groups. Examples of suitable functional groups include hydroxyl groups. Alternatively, the polymers may comprise carboxylic acid or carboxylic acid derivatives, alone or in combination with the hydroxyl groups.

In one or more embodiments, the polymer shell described above, of the core-shell particle, may be a polymacrolactone comprising the desired functional groups. Polymacrolactones comprise, or in some embodiments consist of, recurring units derived from macrolactones. Such macrolactones may be selected from the group consisting of undecalactone, dodecalactone, hexadecalactone, globalide, ambrettolide, 6-hexadecenlactone, and combinations thereof.

In one or more embodiments, the polymer shell of the core-shell particle may be a copolymer of a macrolactone monomer and other monomer units. In such embodiments, the polymacrolactones comprise at least 50 mol %, 60 mol %, 70 mol %, 80 mol %, or 90 mol % of recurring units derived from macrolactones. Suitable comonomers may include for example, monomers comprising an epoxy group, however one skilled in the art would appreciate that any monomer capable of reacting with a macrolactone or polymacrolactone may be used.

The number average molecular weight of the polymacrolactone may be in a range having a lower limit of any one of 10,000 g/mol, 20,000 g/mol, 30,000 g/mol, 40,000 g/mol, and 50,000 g/mol to an upper limit of any one of 6,000 g/mol, 8,000 g/mol, 10,000 g/mol, 20,000 g/mol, 30,000 g/mol, 40,000 g/mol, 50,000, g/mol, 60,000 g/mol, 70,000 g/mol, 80,000 g/mol, 90,000 g/mol, and 100,000 g/mol where any lower limit may be used in combination with any upper limit which is larger than the selected lower limit.

In one or more particular embodiments, a silica particle may be grafted with at least one polymacrolactone (PML) to form a silica-PML. The silica-PML may be used as the crosslinking agent to dynamically crosslink the polyolefin matrix.

In one or more embodiments, the crosslinking agent may be dispersed in the polyolefin matrix to form a polymeric composite composition having a polyolefin matrix phase and a dispersed phase comprising the crosslinking agent. The crosslinking agent may be present in the polymeric composite composition in an amount ranging from a lower limit of any one of 10 wt %, 11 wt %, 12 wt %, 13 wt %, 14 wt %, and 15 wt % to an upper limit of any one of 15 wt %, 16 wt %, 17 wt %, 18 wt %, 19 wt %, and 20 wt %, where any lower limit may be used in combination with any upper limit.

### Method of Preparing a Crosslinking Agent

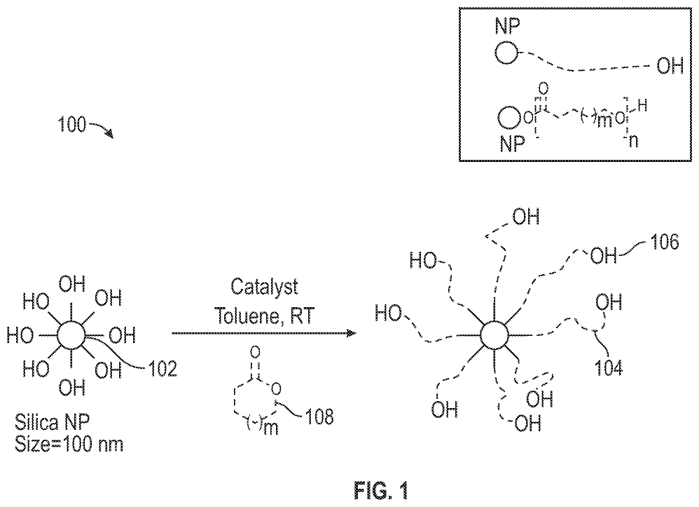

One or more embodiments of the present disclosure relate to a method of preparing the previously described crosslinking agent. A schematic illustration of a method 100 of preparing the crosslinking agent is shown in FIG. 1. The crosslinking agent may generally be prepared by functionalizing a core particle 102 to form a shell 104, which includes a desired functional group 106. In the embodiment shown in FIG. 1, the core particle 102 is a silica particle with hydroxyl groups on the surface and the shell 104 is PLMs having hydroxyl groups as the functional group 106.

In one or more embodiments, the core particle may be a silica particle synthesized via a Stöber process. The Stöber process involves the hydrolysis of a tetraalkylorthosilicate to form monodisperse silica particles as is known by those skilled in the art. In other embodiments, the core particle may be a commercially available silica particle, such as Evonik Aerosil® products. The silica particles described herein generally include —OH groups on the surface of the particles.

The silica particle may be functionalized utilizing the —OH group on the surface of the particle. Polymers may be attached to the surface of the core particle in a grafting-to method, or alternatively grown from the surface of the particle in a grafting-from method to introduce the desired functional groups. Surface functionalization may be conducted in the presence of a strong base catalyst. The strong base may be a phosphazene, however any other catalyst suitable for the ring-opening polymerization of macrolactones may be used.

In one or more embodiments, and as shown in FIG. 1, the silica particle 102 is suspended in a solvent, such as toluene, with a catalyst. At least one macrolactone 108 is introduced and polymerization is allowed to proceed. The polymerization may be conducted for at least 60 min and up to 8 hours. The polymerization may be allowed to proceed at a temperature of at least 60° C., 70° C., 80° C., or 90° ° C. and of at most 90° C., 100° ° C., or 110° C. The silica may be present in the polymerization reaction mixture in an amount of up to 20 wt %. Upon completion of the polymerization, observable by NMR analysis, the synthesized silica-PML is washed with toluene and isolated, such as by filtration, centrifugation, or any other suitable method.

### Polyolefin Matrix

As noted above, polymeric composite compositions disclosed herein comprise a polyolefin matrix comprising at least one polyolefin. The polyolefin matrix is not particularly limited. Examples of polyolefins according to the present disclosure include polyethylene and polypropylene. The polyethylene may be high-density polyethylene.

The molecular weight and the polydispersity index of the polyolefin comprised in the polyolefin matrix are not particularly limited. As such, any suitable polyolefin may be used.

One skilled in the art may appreciate that a polyolefin may be synthesized according to appropriate methods known in the art or obtained commercially.

The polyolefin matrix may be present in the polymeric composite composition in an amount ranging from a lower limit of any one of 60 wt %, 70 wt %, and 80 wt % to an upper limit of any one of 90 wt %, 95 wt %, 99 wt %, and 99.9 wt %, where any lower limit may be used in combination with any upper limit.

In one or more embodiments, the polyolefin matrix includes functional groups capable of undergoing dynamic crosslinking reactions. Conventionally, crosslinking reactions form irreversible covalent bonds between individual polymer chains, forming a network. Dynamic crosslinking utilizes reversible covalent bonds to form the network. In a dynamically crosslinked system, the reversible bonds may be broken and/or reformed into new crosslinks. An example of a suitable functional group capable of undergoing dynamic crosslinking is an epoxide group. Epoxide groups may be introduced to the polyolefin matrix by incorporation of glycidyl methacrylate, for example. For example, high-density polyethylene may be grafted with glycidyl methacrylate to form the epoxide functionalized high-density polyethylene (HDPE-g-GMA). Alternatively, a monomer such as ethylene may be copolymerized with glycidyl methacrylate to provide the epoxide-grafted polyolefin matrix. The polyolefin matrix may also be a copolymer, such as a copolymer of ethylene and propylene. The functional groups capable of undergoing dynamic crosslinking reactions may be present in the polyolefin matrix in an amount ranging from a lower limit of any one of 1 mol %, 5 mol %, 10 mol %, 20 mol %, 25 mol %, 30 mol %, 35 mol %, and 40 mol % to an upper limit of any one of 30 mol %, 35 mol %, 40 mol %, 45 mol %, and 50 mol %, where any lower limit may be used in combination with any upper limit.

### Catalyst

Polymeric composite compositions according to one or more embodiments may further comprise a catalyst. The catalyst may be any catalyst capable of catalyzing a dynamic crosslinking reaction as described above. Catalysts may include a phosphazene base. The catalyst may be present in an amount ranging from a lower limit of any one of 0.1 wt %, 0.5 wt %, 1 wt %, and 2 wt % to an upper limit of 2 wt %, 3 wt %, 4 wt %, and 5 wt % where any lower limit may be used in combination with any upper limit.

### Additives

Polymeric composite compositions according to one or more embodiments may further comprise one or more additives. Additives may include, but are not limited to pigments, antioxidants, UV absorbers, fillers, anti-blocking agents, and impact modifiers. Pigments may include carbon black, titanium dioxide, chrome red, and chrome green. Antioxidants may include phosphites or phenolics. UV absorbers may include benzophenones and benzotriazoles. Fillers may include silicates, carbonates, clays, cellulose, and organic or inorganic fibers. Anti-blocking agents may include silica, clays, carbonates, sulfates, amides, fatty acids, fatty acid amides, and silicones. Impact modifiers may include for example glass fibers, ceramic fibers, thermoplastic resins, and thermoplastic elastomers. Additives may be present in an amount ranging from a lower limit of any one of 0.1 wt %, 0.5 wt %, 1 wt %, 2 wt %, 3 wt %, 4 wt %, and 5 wt % to an upper limit of 5 wt %, 6 wt %, 7 wt %, 8 wt %, 9 wt %, and 10 wt % where any lower limit may be used in combination with any upper limit.

### Method of Preparing Polymeric Composite Composition

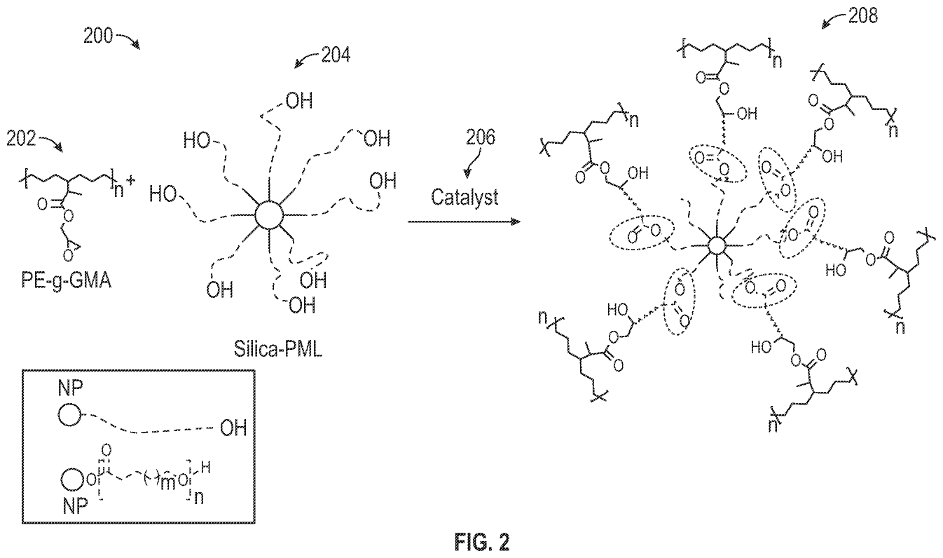

One or more embodiments of the present disclosure relate to a method of preparing the previously described polymeric composite composition. A schematic illustration of a method according to one or more embodiments is shown in FIG. 2. In the reaction scheme 200 shown in FIG. 2, a polyolefin matrix 202 is reacted with a silica-PML 204 in the presence of a catalyst 206 to form the polymeric composite 208.

The method may include melting a polyolefin matrix, introducing at least one crosslinking agent to the melted polyolefin matrix, and mixing the crosslinking agent with the melted polyolefin matrix. Methods may also include introducing one or more additives to the polyolefin matrix and mixing the melted polyolefin with the additives and the crosslinking agent.

The melting may be performed at a temperature sufficient to melt the polyolefin matrix. For example, the polyolefin may be heated to a temperature of at least 5 to 10 degrees over the melting temperature of the polyolefin. For example, in some particular embodiments, the melting temperature may be between 110° C. and 140° C. However, any temperature suitable to melt the matrix polymer may be used.

The crosslinking agent may be introduced into the melted polyolefin matrix in a single batch addition, multiple batch addition, or in a continuous process. The polyolefin matrix may be mixed with the crosslinking agent and any optional additives using any conventional mixing means, such as by mixing in conventional kneaders, Banbury mixers, mixing rollers, extruders and the like. In one or more particular embodiments, the melting and mixing may be performed in an extruder, such as single- or twin-screw extruder.

The polymer composite compositions described herein may be further processed into useful articles. The processing may include melting the polymeric composite composition and molding the polymeric composite composition. More particularly, the polymeric composite composition may be provided as a melt. The melt may be obtained directly from the production of the polymeric composite composition. The polymeric composite composition may be extruded into a mold, or may be molded directly to form the desired article.

Alternatively, the polymeric composite composition may be provided as a billet, pellets, powder, a pre-formed article, or any other suitable form. The polymeric composite composition may be heated to a sufficient temperature to break and re-form the dynamic crosslinks and to perform a dynamic crosslinking reaction.

During re-processing, the polymeric composite composition may be heated to a temperature of at least 100° C. and up to 140° C., however any temperature suitable to melt the matrix polymer and cause the breaking and reforming of the dynamic crosslinks may be used. The reprocessing may be performed on a billet, pellets, powder, a pre-formed article, or any other suitable form. The reprocessed polymeric composite composition may be extruded into a mold, or may be molded directly to form the desired article.

### Article

In some embodiments, the present disclosure relates to an article made from the previously described polymeric composite composition. In one or more embodiments, the article may be a pallet.

### Examples

### Preparation of Silica-PML

Silica particles were prepared by addition of 17.5 mL of tetraethoxysilane (TEOS) to a solution of 200 mL of ethanol and 75 mL of ammonium hydroxide (28%). A white solution appeared and was left to stir overnight. The following day, the solution was purified by repeated centrifugation in absolute ethanol and left to dry overnight in air. The obtained silica particles (Silica-OH) were combined with PDL monomer and a catalyst in the ratio [PDL monomer]/[Silica-OH]/[Catalyst]=50:1:1. The reaction was allowed to proceed at 80° C. for 5 days in 100 mL toluene. The reaction was quenched in methanol and filtered. The final silica-PML was characterized via NMR analysis. All reagents were purchased from Sigma Aldrich.

### Preparation of Polymeric Composite Composition

Poly(ethylene-co-glycidyl methacrylate) (Sigma Aldrich, 10 g) was melted for 5 min in an Xplore MC 5.5 mL twin-screw micro-extruder at 180° C. and 60 rpm. Silica-PML (5 g) was added in the presence of phosphazene (0.05 g) as catalyst. The resulting mixture was heated from 5 to 10 minutes at 180° C.

Embodiments disclosed herein may provide advantages over conventional materials known in the art. Polymeric composite compositions according to certain embodiments may provide increased mechanical properties, such as increased tensile, compressional, flexural, torsional, and/or impact strength, as well as increased Young's modulus. Further, Polymeric composite compositions may exhibit enhanced recyclability and reprocessability, compared with conventional thermosetting materials. The low cost of raw materials and ability to be reprocessed may provide additional economic benefit.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. Examples described above in the description of particular embodiments are intended to be included, but embodiments are not limited to the examples described above. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A crosslinking agent comprising:
a core particle; and
a shell on a surface of the core particle comprising at least one polymacrolactone.

2. The crosslinking agent according to claim 1, wherein the core particle is a silica particle.

3. The crosslinking agent according to claim 1, wherein a size of the core particle ranges from 100 nm to 3 μm.

4. The crosslinking agent according to claim 1, wherein the at least one polymacrolactone comprises a hydroxyl group.

5. The crosslinking agent according to claim 1, wherein the at least one polymacrolactone comprises recurring units selected from the group consisting of undecalactone, dodecalactone, pentadecalactone, hexadecalactone, globalide, ambrettolide, 6-hexadecenlactone, and combinations thereof.

6. The crosslinking agent according to claim 1, wherein the at least one polymacrolactone has a molecular weight ranging from 10,000 g/mol to 100,000 g/mol.

7. A polymeric composite composition comprising:
a polyolefin matrix comprising at least one polyolefin, wherein the polyolefin is functionalized to comprise functional groups; and
a crosslinking agent, wherein the crosslinking agent comprises:
a core particle, and
a shell on a surface of the core particle comprising at least one polymacrolactone.

8. The polymeric composite composition according to claim 7, wherein the polyolefin is selected from the group consisting of high-density polyethylene and polypropylene.

9. The polymeric composite composition according to claim 7, wherein the polyolefin is functionalized with epoxide groups.

10. The polymeric composite composition according to claim 7, wherein the polyolefin matrix is present in an amount ranging from 60 wt % to 99.9 wt % based on a total weight of the composition.

11. The polymeric composite composition according to claim 7, wherein the core particle is a silica particle.

12. The polymeric composite composition according to claim 7, wherein the at least one polymacrolactone comprises recurring units selected from the group consisting of undecalactone, dodecalactone, pentadecalactone, hexadecalactone, globalide, ambrettolide, 6-hexadecenlactone, and combinations thereof.

13. The polymeric composite composition according to claim 7, wherein the crosslinking agent is present in an amount ranging from 0.1 wt % to 20 wt % based on a total weight of the composition.

14. The polymeric composite composition according to claim 7, wherein the crosslinking agent is dispersed in the polyolefin matrix.

15. The polymeric composite composition according to claim 7, further comprising at least one additive selected from the group consisting of pigments, antioxidants, UV absorbers, fillers, anti-blocking agents, and impact modifiers, and combinations thereof.

16. An article comprising the polymeric composite composition according to claim 7.

17. The article according to claim 16, wherein the article is a pallet.

18. A method of preparing a polymeric composite composition, the method comprising:
melting a polyolefin matrix to form a melted polyolefin matrix; and
mixing a crosslinking agent with the melted polyolefin matrix to form the polymeric composite composition, wherein the crosslinking agent comprises:
a core particle, and
a shell on a surface of the core particle comprising at least one polymacrolactone.

19. The method according to claim 18, wherein the melting and mixing is performed in an extruder.
